(19) United States
(12) Patent Application Publication
(10) Pub. No.: US 2010/0138833 A1
(43) Pub. Date: Jun. 3, 2010

(54) RESOURCE COVERAGE AND ANALYSIS

(75) Inventors: Timothy C. Franklin, Kirkland, WA (US); Poon Rojanasoonthon, Bellevue, WA (US); Brian Wang, Bellevue, WA (US); Oliver Szimmetat, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/325,291

(22) Filed: Dec. 1, 2008

(51) Int. Cl. G06F 9/46

(52) U.S. Cl. 718/100

(57) ABSTRACT

User interfaces called by a target application can be quickly and efficiently identified and stored for future resource coverage analysis. User interfaces of the target application that are accessed by users executing the target application on their computing device can be automatically tracked during execution of the target application. Information gathered on user interfaces of a target application and accessed user interfaces of the target application can be employed to generate one or more reports. Generated reports on user interface usage can be used to, e.g., identify the application resources to localize, prioritize the application resources to localize, discern application resource trends for, e.g., maintenance and upgrade activities, detect unused application resources, and select appropriate application resources for test scenarios.

### BACKGROUND

Computers and computer-based devices, e.g., BLACKBERRY® hand-held devices, computer-based cell phones, etc., collectively referred to herein as computing devices, have the capability of running software applications with UI (user interface) components. In general, UIs allow users to interact with the software, e.g., to input information, make choices, etc., and UIs provide information to a user of the software, e.g., error messages, time to task finish, etc.

For a variety of uses it would be advantageous to identify the UI resources, e.g., dialogs, strings, etc., that are accessed by any user of a software application. It would also be helpful to identify those UI resources of a software application that are most often accessed by users.

For example, the identification of accessed UI resources of a software application can serve to create application tests to exercise the most popular features of a software application. This information can be applied to efficiently and cost effectively design application tests to ensure more robust software application experiences.

Additionally, the identification of the most popular UI resources of a software application can be used by localization teams tasked with creating UI translations. This information can effect efficient and cost effective translations for a software package. For example, the identification of the most popular UI resources of a software application can be used by localization teams to translate only those most popularly accessed UI resources, creating effective cost savings while still ensuring robust user experiences. This information can also, or otherwise, be used by localization teams to prioritize translation efforts to translate the most popular UI resources of a software application first.

Moreover, the identification of UI resources that are activated, or otherwise accessed, by any user of a software application can be employed to diagnose use flows for streamlining, maintaining and enhancing software packages.

There are additional utilities for information on UI resource usage that can be gathered quickly and cost effectively. Thus, it would be desirable to accurately identify the UI resources of a software application that are accessed by any user and to accurately identify the most frequently accessed UI resources of a software application. It would further be desirable to reduce the cost, both in terms of manpower energy expended and time to achieve, of identifying accessed, and most popularly accessed, UI resources of a software application.

### SUMMARY

This summary is provided to introduce a selection of concepts in a simplified form that are further described below in the Detailed Description. This summary is not intended to identify key or essential features of the claimed subject matter, nor is it intended to be used as an aid in determining the scope of the claimed subject matter.

Embodiments discussed herein include systems and methodology for tracking and analyzing resource usage in one or more target applications. In an embodiment resources of an application are identified and thereafter noted when they are loaded by an application executing on a user's computing device. In an embodiment loaded resources that are then accessed by, or otherwise displayed to, a user are indicated as covered. In embodiments information on covered resources is used, along with information on all resources of an application, to generate one or more reports for resource coverage analysis.

In embodiments information provided by a user of a target application is included with information on covered resources for subsequent resource coverage analysis. In embodiments information on a user's computing device executing a target application is included with information on the application's covered resources for subsequent resource coverage analysis.

### BRIEF DESCRIPTION OF THE DRAWINGS

These and other features will now be described with reference to the drawings of certain embodiments and examples which are intended to illustrate and not to limit the invention, and in which:

FIG. 1 depicts an embodiment system for implementing resource coverage analysis.

FIG. 2 illustrates an embodiment resource usage file containing information on covered resources of a target application.

FIG. 3A depicts an exemplary local dictionary, exemplary target application executables and exemplary user supplied resource.

FIGS. 3B-3D depict exemplary user displayed resources.

FIG. 4 illustrates an embodiment logic flow for remote resource coverage analysis implementation.

FIGS. 5A-5B illustrate an embodiment logic flow for local resource coverage analysis implementation.

FIG. 6 is a block diagram of an exemplary basic computing device system that can process software, i.e., program code, or instructions.

### DETAILED DESCRIPTION

In the following description, for purposes of explanation, numerous specific details are set forth in order to provide a thorough understanding of the present invention. It will be apparent, however, to one skilled in the art that the invention may be practiced without these specific details. In other instances well-known structures and devices are shown in block diagram form in order to avoid unnecessarily obscuring the invention. Any and all titles used throughout are for ease of explanation only and are not for use in limiting the invention.

In an embodiment UIs, also referred to herein as resources, of an application executable on a user's computing device that are accessed, or otherwise used, by a user are tracked. In an embodiment information gathered about accessed UIs can be used to generate one or more reports that can, e.g., identify the percentage of an application's resources that are accessed, identify the application resources that are used, identify the application resources that are used most frequently, identify application resources that are not used, and identify user resource interaction trends. This information can be employed to, e.g., identify the application resources to localize, i.e., translate into one or more languages, prioritize the application resources to be localized, discern application resource trends for, e.g., maintenance and upgrade activities, detect unused application resources, and select appropriate application resources for test scenarios.

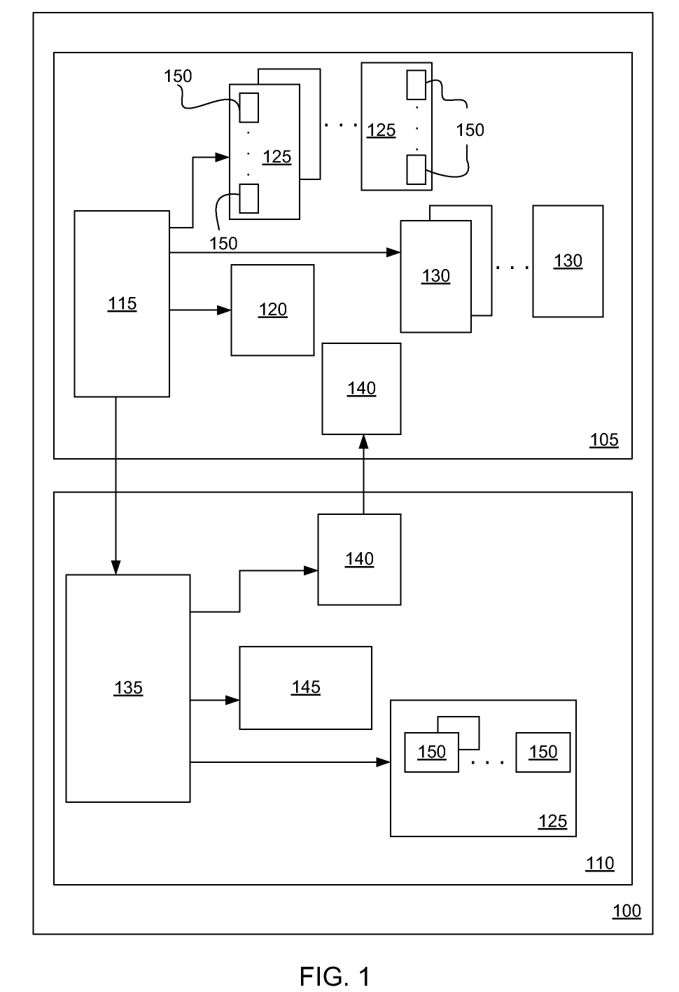

Referring to FIG. 1, in an embodiment resource coverage analysis system, also referred to herein as a RCA system, 100 resource coverage analysis software, i.e., RCA software, 115 is hosted on a computing device system, e.g., a system server 105. In an embodiment one or more applications 125 to be analyzed for resource coverage, otherwise referred to herein as target applications 125 or applications 125, are also hosted on, or otherwise accessible by, the computing device system 105.

In an embodiment the RCA software 115 scans the binaries of each target application 125 and identifies all the UIs, or resources, 150 of each application 125. In an embodiment the RCA software 115 identifies all resources 150 of an application 125 with any reference in the application 125 whether or not the resource 150 is ultimately loaded, called or displayed to a user. In an embodiment the RCA software 115 identifies the resources 150 of each application 125 for future use in discerning resource coverage of an application 125 once the application 125 is used and its resources displayed to a user are identified, as further described below.

In an embodiment the RCA software 115 stores an identification of each resource 150 of an application 125 in a system database 120 on, or otherwise accessible by, the computing device system 105. In an embodiment for each application resource 150 the RCA software 115 stores the resource's source file, or an indication thereof, and the location of the resource within the source file, or an indication thereof, in the system database 120. For example, a system database entry for the fifteenth (15^{th}) entry of the string table of a calc.exe file of a target application 125 designates, or otherwise indicates, the calc.exe file source and the string table #15 resource location. As another example, a system database entry for the tenth (10^{th}) dialog item of the one hundredth (100^{th}) dialog in a myfile.exe file of a target application 125 designates, or otherwise indicates, the myfile.exe source and the dialog 100, dialog item 10 resource location.

In an embodiment one system database 120 holds, or otherwise indicates, the identifications of all resources 150 of all the target applications 125. In an alternate embodiment separate system databases 120 hold, or otherwise indicate, the identifications of the resources 150 for each target application 125.

In embodiments the RCA software 115, upon request, upon one or more predetermined events, and/or on a preset time schedule, uses information in the system database(s) 120 to generate one or more reports 130. In embodiments a generated report 130 provides resource usage information for a user of an application 125, a group of users of an application 125, and/or all users of an application 125. In embodiments a generated report 130 provides resource usage information for an application 125, for a group of applications 125 and/or for all applications 125. In embodiments a generated report 130 provides resource usage information for a session use of an application 125, for one or more predefined number of session uses of an application 125, for one or more predefined time spans of session use(s) of an application 125 and/or for all session uses of an application 125 to date. In an embodiment a session use of an application 125 is one instantiation, or one execution, of the application 125.

In an embodiment a generated report 130 can include, e.g., an identification of the resources 150 of an application 125 accessed by a user, the number of session uses in which a resource 150 of an application 125 was accessed by a user, the percentage of users accessing a resource 150 of an application 125 and resource usage statistics based on, e.g., users' gender, computer experience and/or age. In embodiments a generated report 130 can have predefined information and/or the information included can be tailored by an analyst, i.e., a user of the resource coverage analysis system 100.

In an embodiment the report(s) 130 are provided for analyst review via the internet.

In an embodiment local resource coverage analysis software, also referred to herein as a local RCA, 135 is, upon user consent, downloaded, installed and activated on a user's computing device 110. In an aspect of this embodiment a user opts into accepting the local RCA 135, or otherwise initiates the acceptance and download of the local RCA to their computing device 110, at which time the local RCA 135 is downloaded, installed and activated on the user's computing device 110. In an aspect of this embodiment a user opts into accepting the local RCA 135 during a predefined opt in period.

In an embodiment the local RCA 135 is embodied in a dynamically linked library, or DLL, selectively loaded into processes running in the operating system on the user's computing device 110. In an alternative embodiment the local RCA 135 is embodied in an EXE, or executable file.

In an embodiment the local RCA 135 generates a local dictionary 145 to identify the resources 150 of an application 125 that are loaded by the application 125 when the application 125 executes on the user's computing device 110.

In an embodiment, when an application 125 executes on, or by, a computing device 110, the local RCA 135 applies detours, or shims, to temporarily divert the application 125's execution path in order to populate the local dictionary 145 with an identification of each application 125 UI call and/or reference 150, collectively referred to herein as a UI call or resource 150, when the resource 150 is loaded. In an embodiment a hashing algorithm is used to populate the local dictionary 145 with entries for an application 125's UI calls 150. In an aspect of this embodiment a CRC32 hashing algorithm is used to populate the local dictionary 145 with entries for an application 125's UI calls 150. In other aspects of this embodiment other hashing algorithms are used to populate the local dictionary 145 with entries.

In an embodiment for each application UI call 150 the local dictionary 145 stores the resource's source file, or an indication thereof, and the location of the resource within the source file, or an indication thereof. For example, a local dictionary entry for the fifteenth (15^{th}) entry of the string table of a calc.exe file of a target application 125 designates, or otherwise indicates, the calc.exe source and the string table #15 resource location. As another example, a local dictionary entry for the tenth (10^{th}) dialog item of the one hundredth (100^{th}) dialog in a myfile.exe file of a target application 125 designates, or otherwise indicates, the myfile.exe and the dialog 100, dialog item 10 resource location.

In an alternative embodiment the local dictionary 145 stores a memory pointer for each loaded UI call resource 150.

In an embodiment new entries are added to the local dictionary 145 with a hash as the key. In this embodiment a hash key is thereafter used to locate an entry in the local dictionary 145. In this embodiment use of hash keys helps to eliminate memory copying or shifting which could lead to destruction of the local dictionary 145 source data.

In an embodiment, once the local RCA 135 adds appropriate entry(s) to the local dictionary 145 for each UI 150 currently loaded by the execution of the application 125 the local RCA 135 returns control to the application 125.

In an embodiment only one entry for a particular UI, or resource, 150 of an application 125 is included in the local dictionary 145 regardless of the number of times the respective resource 150 is loaded by the application 125.

In an embodiment if a user accesses a resource 150, or a resource 150 is otherwise called or executed, so that the resource 150 is displayed to a user the local RCA 135 searches the local dictionary 145 for an entry for the UI 150. In an aspect of this embodiment the local RCA 135 uses a hash key for the displayed UI 150 to search the local dictionary 145 for a matching resource entry. In this embodiment aspect if a match to the currently displayed UI 150 is found in the local dictionary 145 the displayed UI 150 is logged as covered.

In an embodiment when a user accessed UI 150 cannot be tracked in the local dictionary 145 using a hash key substring searching is used to verify the unique resource location of the accessed UI 150 in the target application 125. In an embodiment where substring searching is used, if the accessed UI 150 is identified in the local dictionary 145 the displayed UI 150 is logged as covered.

In an embodiment covered resources are logged, or otherwise noted or indicated, in a resource usage file 140 that can be accessed, uploaded or otherwise exported to the computing device system 105.

In an embodiment the resource usage file 140 is an XML file. In an embodiment covered resources are logged chronologically to the resource usage file 140. In an embodiment additional data, e.g., source file, resource location, etc., is logged with the resource indication to the resource usage file 140.

In an embodiment a resource 150 is logged only once to the resource usage file 140 regardless of the number of times the resource 150 is displayed to a user in a session, i.e., in the current execution of the application 125. In an alternative embodiment each time a resource 150 is displayed to a user in a session the resource 150 is logged to the resource usage file 140. In a second alternative embodiment a counter is associated with the entries of the resource usage file 140 and each time a resource 150 is displayed to a user in a session the appropriate counter is, on the first instance, initiated, and on subsequent instances, incremented. In a third alternative embodiment resources 150 of an application 125 are categorized. In this third alternative embodiment resources 150 from some categories, when the resource 150 is logged to the resource usage file 140, have counters associated with their file entries that are, on the first instance, initiated, and on subsequent instances, incremented. In this third alternative embodiment resources 150 in other categories have no counters associated with their file entries and these resources 150 are logged, or otherwise indicated, once to the resource usage file 140.

In embodiments the entries of the resource usage file 140 are streamed, or otherwise uploaded or exported, to the computing device system 105 when any new entry is added to, or updated in, the resource usage file 140, after a predefined number of additions and/or updates to the resource usage file 140, and/or at predefined time intervals. In an alternative embodiment the resource usage file 140 is streamed, or otherwise uploaded or exported, to the computing device system 105 when the current application 125 session terminates.

In an embodiment entries of the resource usage file 140 are streamed to the computing device system 105 by a telemetry application also used for streaming telemetry data to the computing device system 105.

In an embodiment the information in the resource usage file 140 uploaded, or otherwise made accessible, to the computing device system 105 is maintained in a resource usage file 140 on the computing device system 105. In an alternative embodiment the information in the resource usage file 140 uploaded to the computing device system 105 is stored in the system database(s) 120.

In an embodiment the RCA software 115 uses the resource usage file 140 information and the system database 120 information for an application 125 to generate one or more reports 130 on resource usage for the application 125.

In an alternative embodiment the local RCA software 135 scans the binaries of a target application 125 and identifies all the UIs, or resources, 150 of the application 125. In this alternative embodiment the local RCA software 135 stores an identification of each application resource 150 in a system database 120 stored on, or otherwise accessible to, the user's computing device 110. In an aspect of this alternative embodiment the local RCA software 135 identifies all the resources 150 of a target application 125 for future use in discerning resource coverage for the target application 125 once the target application 125 is used and its resources displayed to a user are identified.

In this alternative embodiment the system database 120 is accessible by, or otherwise uploaded or exported to, the computing device system 105.

In an aspect of this alternative embodiment the local RCA software 135 generates a system database 120 for an application 125 when the application 125 is installed on the user's computing device 110. In an alternative aspect of this alternative embodiment the local RCA software 135 generates the system database 120 for an application 125 each time the application 125 is executed on, or by, the user computing device 110.

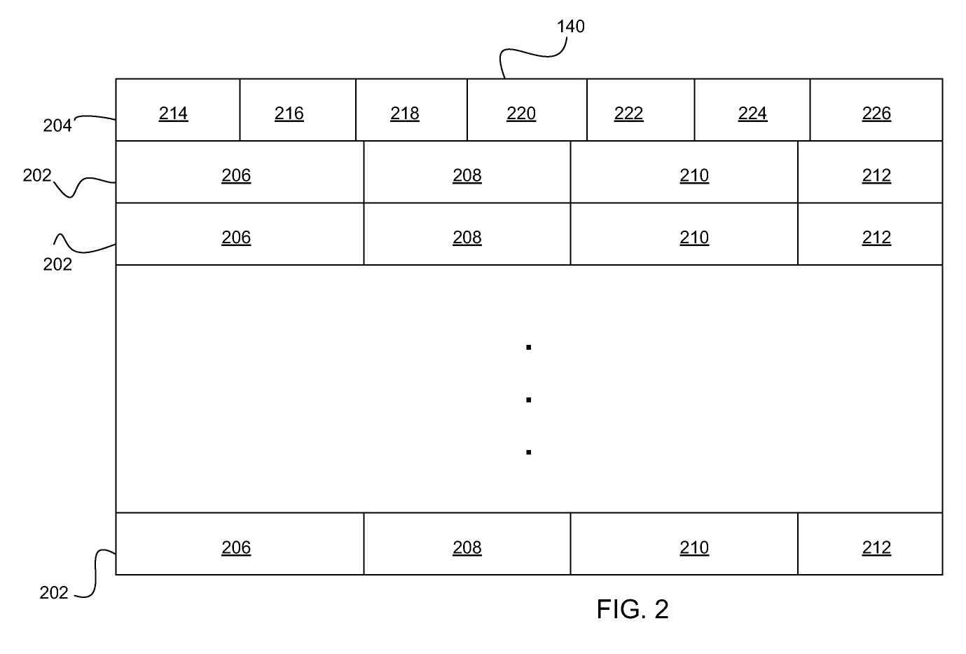

FIG. 2 illustrates an embodiment resource usage file 140 for covered resources of a target application 125. In other embodiments the resource usage file 140 generated on a user's computing device 110 can be in other formats, e.g., a database, etc., contain more, less and/or different information, and/or the data it contains can be composed in alternative arrangements.

In an embodiment the resource usage file 140 is a plain text XML, extensible markup language, file.

In an embodiment the resource usage file 140 contains one or more entries, or records, 202 which each identify a covered resource of a target application 125. In an embodiment each entry 202 has an identification of a covered resource 206 that has been used, or otherwise accessed or displayed, to a user.

In an embodiment each entry 202 has an identification of the source file 208 from which the covered resource originated. In an embodiment each entry 202 has an identification of the location of the covered resource in a target application source file 210. For example, in this embodiment an entry 202 can identify a covered resource location 210 as “string table #15,” which in this example indicates that the covered resource is the fifteenth (15^{th}) entry in the source file's string table. In an alternative embodiment each entry 202 has an identification of the resource location in memory 210 that the respective covered resource was loaded to.

In an embodiment each entry 202 has a counter 212 that identifies the number of times the respective covered resource was used in an application execution session.

In an embodiment the resource usage file 140 contains one or more entries, or records, 204 that identify one or more characteristics of the user of the target application 125. In an embodiment all user characteristics are knowingly volunteered, or otherwise provided by, the user.

In embodiments the resource usage file entry(s) 204 also, or alternatively, identify one or more characteristics of the user's computing device 110. In an embodiment all user computing device characteristics identified in the resource usage file entry(s) 204 are included with the express permission of the user of the computing device 110.

In an embodiment the entry(s) 204 has an identification of the user's age group 214. In an embodiment the entry(s) 204 has an identification of the user's gender 216. In an embodiment the entry(s) 204 has an identification of the user's computer experience 218, e.g., novice, intermediate, advanced, etc. In an embodiment the entry(s) 204 has an identification of the user's preferred language 220.

In an embodiment the entry(s) 204 has an identification of the computing device's machine id 222. In an embodiment the entry(s) 204 has an identification of the computing device type 224, e.g., personal computer (pc), cell phone, etc. In an embodiment the entry(s) 204 has an identification of the country location of the computing device 226, e.g., United States, Canada, etc.

As noted, embodiment resource usage files 140 can contain less information, additional information, and/or different types of information, e.g., an indication of the user's satisfaction with the target application 125, an indication of the time zone that the computing device 110 is located in, etc.

In embodiments statistics on users and computing devices 110 executing target applications 125 can be used with information on covered resources of the target applications 125 to, e.g., identify the application resources to localize, prioritize the application resources to localize, discern application resource trends for, e.g., maintenance and upgrade activities, detect unused application resources, and select appropriate application resources for test scenarios.

In an embodiment the local RCA 135 handles dynamic resource combination manipulation in which two or more resources 150 are loaded from multiple application source locations and combined to create a new, combination, resource 150 that can be presented, or displayed, to a user. In an embodiment resources 150 of a combination, or combined, resource 150 that are found in the source file(s) of a target application 125 are associated by the local RCA 135 into a new entry in the local dictionary 145. In this embodiment one or more resources 150 of a combined resource 150 that are not found in a source file of the target application 125, e.g., they are provided at runtime, are ignored.

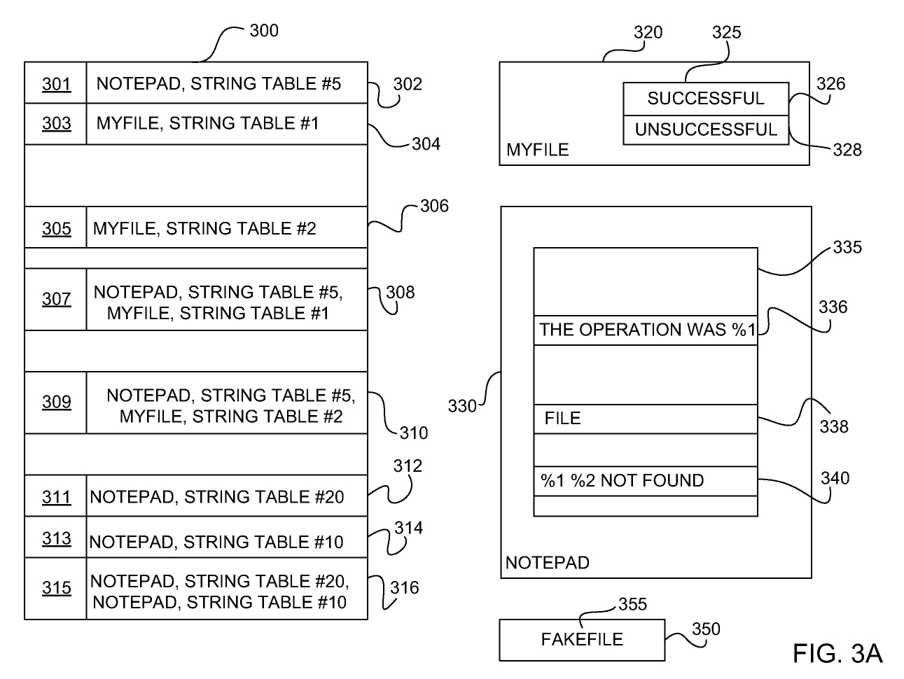

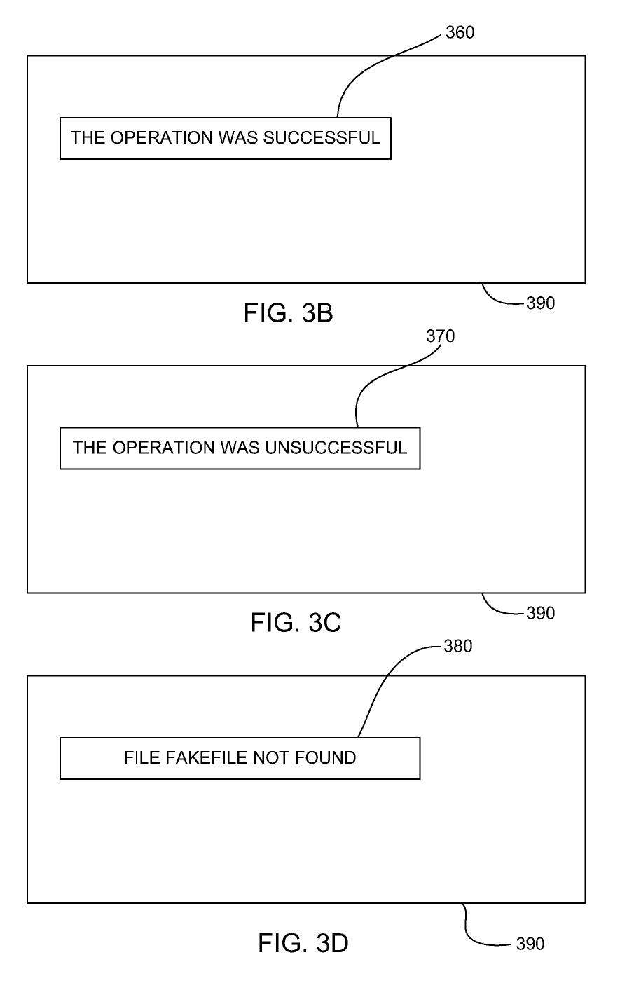

Various examples of dynamic resource combination manipulation are depicted in FIGS. 3A, 3B, 3C and 3D. Referring to FIG. 3A, as a first example the string resource “The operation was % 1” is the fifth (5^{th}) string 336 in the string table 335 of the notepad executable 330. In an embodiment, when this fifth string 336 is loaded during execution of notepad 330 the local RCA 135 stores an entry 302 in a local dictionary 300. In an embodiment the local dictionary entry 302 includes a hash key 301 for the entry 302, an indication of the source file, notepad 330, and an indication of the resource location in the source file, string table #5 336.

The executable myfile 320 also has an associated string table 325 with two resource entries: resource entry 326 for a first string, “successful,” and resource entry 328 for a second string, “unsuccessful”. In an embodiment, when the first string “successful” is loaded during execution of myfile 320, the local RCA 135 stores an entry 304 in the local dictionary 300 which, in an embodiment, includes a hash key 303 for the entry 304, an indication of the source file, myfile 320, and an indication of the resource location in the source file, string table #1 326. Likewise, in an embodiment, when the second string “unsuccessful” is loaded during execution of myfile 320, the local RCA 135 stores an entry 306 in the local dictionary 300 which, in an embodiment, includes a hash key 305 for the entry 306, an indication of the source file, myfile 320, and an indication of the resource location in the source file, string table #2 328.

In this first example, during execution of the target application 125 the resource string “The operation was % 1” and the resource string “successful” are combined and loaded as a combination resource “The operation was successful” 360, shown in FIG. 3B.

In an embodiment shims are employed to monitor the functions that perform the substitution of the resource “successful” for “% 1” to generate and load the combination resource “The operation was successful” 360 of FIG. 3B. In an embodiment, at the time the combination resource 360 is generated and loaded the local RCA 135 creates a new entry 308 in the local dictionary 300, noting any source information for the respective resources of the combination resource 360 that the local RCA 135 has.

In this example, at the time the combination resource 360 is generated and loaded the local RCA 135 employs a shim to analyze the new combination resource 360. In this example the local RCA 135 has source information for both resources that are combined to create the combination resource “The operation was successful” 360. Thus, in this example in an embodiment the local RCA 135, using the hash of each respective resource of the combination resource 360 as a key, generates a new entry 308 in the local dictionary 300. In an embodiment the local dictionary entry 308 for the combination resource “The operation was successful” 360 includes a hash key 307 for this new entry 308; an indication of the source file, notepad 330, for “The operation was % 1” resource in the combination resource 360 and an indication of this resource location in the notepad source file 330, string table #5 336; and an indication of the source file, myfile 320, for the “successful” resource in the combination resource 360 and an indication of this resource location in the myfile source file 320, string table #1 326.

Referring to FIG. 3B, in this first example, if a user is thereafter presented with the combination resource 360 displayed on their computing device screen 390, in an embodiment the local RCA 135 will search the local dictionary 300 for an entry for this combination resource 360. In an aspect of this embodiment the local RCA 135 uses a hash key for the displayed combination resource 360 to search the local dictionary 300 for the matching resource entry 308. In this embodiment aspect once the local dictionary entry match 308 is found the combination resource 360 is logged as covered.

In a second example, during execution of the target application 125 the resource string “The operation was % 1” and the resource string “unsuccessful” are combined and loaded as a combination resource “The operation was unsuccessful” 370, shown in FIG. 3C.

In an embodiment, at the time the combination resource 370 is generated and loaded the local RCA 135 creates a new entry 310 in the local dictionary 300, noting any source information for the respective resources of the combination resource 370 that the local RCA 135 has. In this second example, at the time the combination resource 370 is generated and loaded the local RCA 135 employs a shim to analyze the new combination resource 370. In this example the local RCA 135 has source information for both resources that are combined to create the combination resource “The operation was unsuccessful” 370. Thus, in this second example in an embodiment the local RCA 135, using the hash of each respective resource of the combination resource 370 as a key, generates a new entry 310 in the local dictionary 300.

In an embodiment the local dictionary entry 310 for the combination resource “The operation was unsuccessful” 370 includes a hash key 309 for this new entry 310; an indication of the source file, notepad 330, for “The operation was % 1” resource in the combination resource 370 and an indication of this resource location in the notepad source file 330, string table #5 336; and an indication of the source file, myfile 320, for the “unsuccessful” resource in the combination resource 370 and an indication of this resource location in the myfile source file 320, string table #2 328.

Referring to FIG. 3C, in this second example, if a user is thereafter presented with the combination resource 370 displayed on their computing device screen 390, in an embodiment the local RCA 135 will search the local dictionary 300 for an entry for this combination resource 370. In an aspect of this embodiment the local RCA 135 uses a hash key for the displayed combination resource 370 to search the local dictionary 300 for the matching resource entry 310. In this embodiment aspect once the local dictionary entry match 310 is found the combination resource 370 is logged as covered.

As noted, in an embodiment one or more resources 150 of a combination, or combined, resource 150 that are not found in a source file of the target application 125, e.g., they are provided at runtime, are ignored. For example, again referring to FIG. 3A, the string resource “% 1 % 2 not found” is the twentieth (20^{th}) resource entry 340 in the string table 335 of the notepad executable 330. In an embodiment, when this twentieth string entry 340 is loaded during execution of notepad 330 the local RCA 135 stores an entry 312 in the local dictionary 300, which, in an embodiment, includes a hash key 311 for the entry 312, an indication of the source file, notepad 330, and an indication of the resource location in the source file, string table #20 340.

The string table 335 for the notepad executable 330 also has an entry 338 for a “File” string, which is this example is the tenth (10^{th}) resource entry 338 in the string table 335. In an embodiment, when this tenth string entry 338 is loaded during execution of notepad 330 the local RCA 135 stores an entry 314 in the local dictionary 300, which, in an embodiment, includes a hash key 313 for the entry 314, an indication of the source file, notepad 330, and an indication of the resource location in the source file, string table #10 338.

In this third example, during runtime a user inputs a filename, fakefile 355, into a designated space 350 on the user's computing device display. In this third example, during execution of the target application 125 the resource string “% 1 % 2 not found,” the resource string “File,” and the user runtime supplied resource string “fakefile” 355 are combined and loaded as a combination resource “File fakefile not found” 380, shown in FIG. 3D.

In an embodiment shims are employed to monitor the functions that perform the substitution of the resource “File” for “% 1” and the substation of the user supplied “fakefile” 355 for “% 2” to generate and load the combination resource “File fakefile not found” 380 of FIG. 3D. In an embodiment, at the time the combination resource 380 is generated and loaded the local RCA 135 creates a new entry in the local dictionary 300, noting any source information for the respective resources of the combination resource 380 that the local RCA 135 has and ignoring resources for which there is no source information, e.g., runtime supplied resources. In this example, at the time the combination resource 380 is generated and loaded the local RCA 135 employs a shim to analyze the new combination resource 380.

In this example the local RCA 135 has source information for two of the three resources that are combined to create the combination resource “File fakefile not found” 380. Thus, in this example in an embodiment the local RCA 135, using the hash of the “% 1 % 2 not found” resource and the hash of the “File” resource as keys, generates a new entry 316 in the local dictionary 300. In an embodiment the local dictionary entry 316 for the combination resource “File fakefile not found” 380 includes a hash key 315 for this new entry 316; an indication of the source file, notepad 330, for the “% 1 % 2 not found” resource and an indication of this resource location in the notepad source file 330, string table #20 340; and an indication of the source file, notepad 330, for the “File” resource and an indication of this resource location in the notepad source file 330, string table #10 338.

In this embodiment and example, the user supplied resource “fakefile” 355 is ignored when the local RCA 135 generates the local dictionary entry 316 for the combination resource “File fakefile not found” 380 as there is no relevant source information for the “fakefile” resource 355.

Referring to FIG. 3D, in this third example, if a user is thereafter presented with the combination resource 380 displayed on their computing device screen 390, in an embodiment the local RCA 135 will search the local dictionary 300 for an entry for this combination resource 380. In an aspect of this embodiment the local RCA 135 uses a hash key for the displayed combination resource 380 to search the local dictionary 300 for the matching resource entry 316. In this embodiment aspect once the local dictionary entry match 316 is found, ignoring runtime supplied resources, e.g., “fakefile” 355, the combination resource 380 is logged as covered.

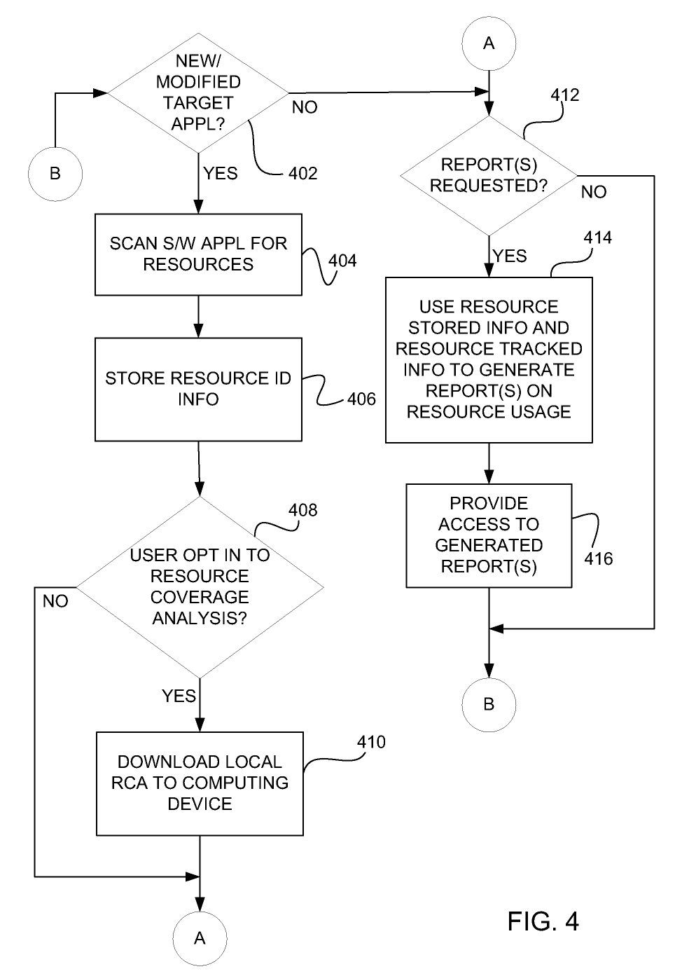

FIG. 4 illustrates an embodiment logic flow for implementing remote resource coverage analysis for one or more target applications. While the following discussion is made with respect to systems portrayed herein, the operations described may be implemented in other systems. Further, the operations described herein are not limited to the order shown. Additionally, in other alternative embodiments more or fewer operations may be performed.

In an embodiment at decision block 402 a determination is made as to whether there is a new target application or a current target application has been modified. If yes in an embodiment a scan of the binaries of the application is made for all resources, or UI calls or references, in or used by the application 404. All identified resources in the application are designated, e.g., in a database, 406.

In an embodiment at decision block 408 a determination is made as to whether a user has opted in to allow local resource coverage analysis software, also referred to herein as a local RCA, to be downloaded and installed and activated on the user's computing device. In an embodiment decision block 408 spans a predefined opt in period in which a user can opt in to resource coverage analysis installing and executing on their computing device.

In an embodiment if a user opts into allowing the local RCA to be downloaded, installed and activated on their computing device then the local RCA is downloaded to and installed and activated on the user's computing device 410.

At decision block 412 a determination is made as to whether one or more resource usage reports are to be generated. In embodiments one or more reports on resource usage are generated upon request, upon one or more predetermined events, and/or on a preset time schedule.

If it is determined that one or more resource usage reports are to be generated then in an embodiment information stored on the resources of an application and information gathered on resource usage when the application executed are used to generate one or more reports 414. In an embodiment information gathered on resource usage when the application executed is uploaded in a resource usage file from a user's computing device to a computing device system for report generation 414.

In an embodiment access to the generated report(s) is provided to one or more analysts, i.e., users of a system tracking resource usage information for one or more target applications, 416. In an aspect of this embodiment access to the generated report(s) is provided to one or more analysts via a web, or internet, interface 416.

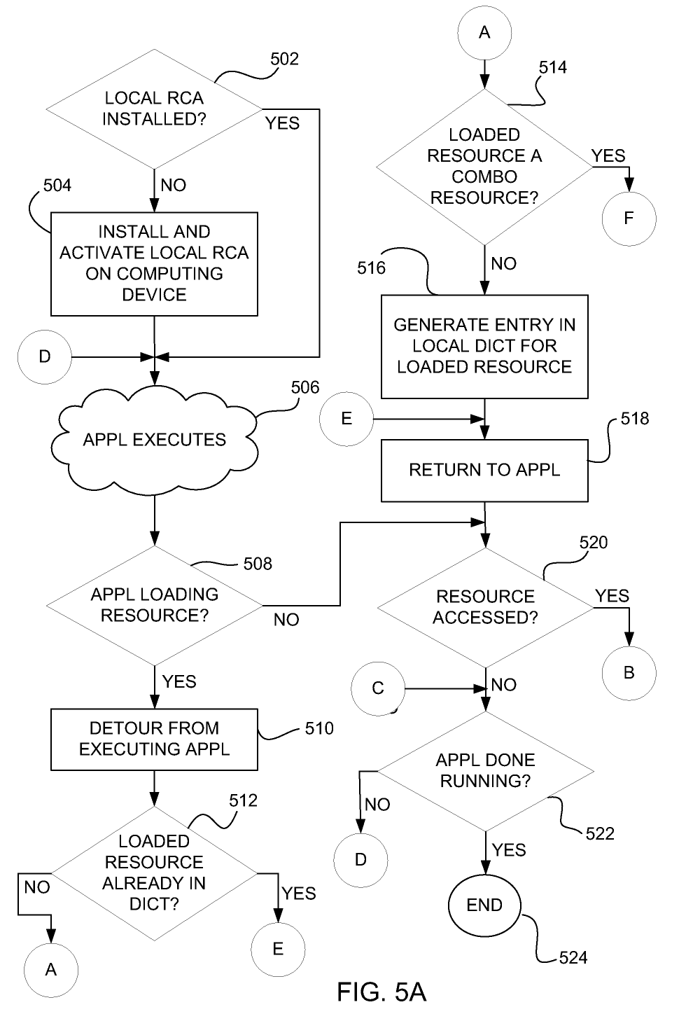

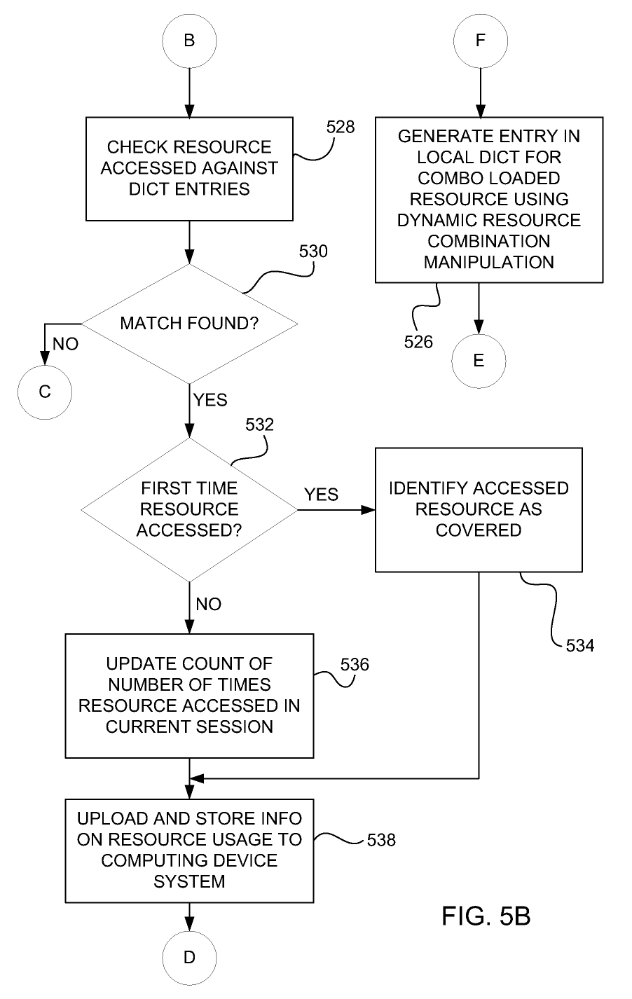

FIGS. 5A and 5B illustrate an embodiment logic flow for implementing local resource coverage analysis for a target application. While the following discussion is made with respect to systems portrayed herein, the operations described may be implemented in other systems. Further, the operations described herein are not limited to the order shown. Additionally, in other alternative embodiments more or fewer operations may be performed.

Referring to FIG. 5A, in an embodiment at decision block 502 a determination is made as to whether a local resource coverage analysis software component, also referred to herein as local RCA, has been installed and activated on the user's computing device. If no, the local RCA is downloaded, installed and activated on the user's computing device 504. In an embodiment the local RCA is downloaded, installed and activated on the user's computing device when the user opts in for resource coverage analysis 504.

As a target application executes on a user's computing device 506 in an embodiment at decision block 508 a determination is made as to whether the application is loading a resource. If yes, in an embodiment a detour, or shim, is applied to momentarily detour the execution of the application 510. In an embodiment at decision block 512 a determination is made as to whether the currently loaded resource has already been identified as a loaded resource of the application. In an aspect of this embodiment at decision block 512 a determination is made as to whether the currently loaded resource is already identified in a database, or dictionary, generated and populated during the current execution session of the target application. In an embodiment the generated database, or dictionary, is a local database or dictionary stored on the user's computing device.

If the currently loaded resource has not already been identified as a loaded resource in an embodiment at decision block 514 a determination is made as to whether the currently loaded resource is a combination resource, i.e., if it is a resource made up of two or more other resources. In an embodiment the local RCA handles dynamic resource combination manipulation in which two or more resources are loaded from multiple application source locations and combined to create a new, combination, resource that can be presented, or displayed, to a user 514. In an embodiment at decision block 514 the local RCA employs a shim to monitor functions that generate and load combination resources.

If at decision block 514 it is determined that the currently loaded resource is not a combination resource, in an embodiment an entry is generated in a database, or dictionary, for the newly loaded resource 516. In an embodiment the newly loaded resource's source file, or an indication thereof, and the location of the resource within the source file, or an indication thereof, is stored in a local dictionary entry for the resource 516. For example, a local dictionary entry for the fifteenth (15^{th}) entry of the string table of a calc.exe file of a target application designates, or otherwise indicates, the calc.exe file and the string table #15 resource location. As another example, a local dictionary entry for the tenth (10^{th}) dialog item of the one hundredth (100^{th}) dialog in a myfile.exe file of a target application designates, or otherwise indicates, the myfile.exe file and the dialog 100, dialog item 10 resource location.

Whether or not the currently loaded resource has already been identified in a database, or dictionary, control is returned to the executing target application 518.

At decision block 514 if a determination is made that the currently loaded resource is a combination resource then, referring to FIG. 5B, in an embodiment an entry is generated in the local database, or dictionary, for the newly loaded resource using dynamic resource combination manipulation 526. An embodiment of dynamic resource combination manipulation is described herein with reference to FIGS. 3A-3D. Referring again to FIG. 5A, control is returned to the executing target application 518.

At decision block 520 a determination is made as to whether the user has accessed a resource of the executing application or a resource has otherwise been presented or displayed to the user.

If no, at decision block 522 a determination is made as to whether the application has concluded executing. If yes, the local resource coverage analysis for the target application is ended for the current application execution session 524.

If at decision block 522 it is determined that the application has not concluded executing, in an embodiment control returns to decision block 508 where a determination is made as to whether the application is loading a resource.

If at decision block 520 it is determined that the user has accessed a resource of the executing application, referring to FIG. 5B a check is made for the resource against the entries identifying loaded resources in the database, or dictionary, 528. In an embodiment if a user accesses a UI, or a UI is otherwise called or executed, so that the UI is displayed to the user the local RCA searches the local dictionary for an entry for the UI 528. In an aspect of this embodiment the local RCA uses a hash key for the displayed UI to search the local dictionary for a matching resource entry 528.

In an embodiment when a user accessed UI cannot be tracked in the local dictionary using a hash key substring searching is used to verify the unique resource location of the accessed UI in the target application 528.

In an embodiment at decision block 530 a determination is made as to whether a match to the currently displayed UI is in the local dictionary. In an embodiment if a match to the currently displayed UI is found in the local dictionary at decision block 532 a determination is made as to whether it is the first time for the current application execution session that the resource has been accessed by the user. If yes, in an embodiment the accessed resource is identified as having been used or is otherwise identified as covered 534. In an embodiment an entry to a database, or file, on or otherwise accessible by the user's computing device is generated to identify an accessed resource as having been used, or covered, in the current application execution session 534. In an embodiment the file, or database, of covered resource entries is a plain text XML, extensible markup language, file.

In an embodiment, as well as an indication that the resource has been used, information on the resource, e.g., source file referencing the resource, resource location in the source file, or, alternatively, memory location, etc., is included, or otherwise associated, with the database, or dictionary, entry for the resource 534.

In an embodiment, as well as an indication that the resource has been used, statistical information on the user and/or user computing device, e.g., user gender, user computer expertise, etc., is included, or otherwise associated, with the database, or dictionary, entry for the resource 534. In an alternative embodiment statistical information on the user and/or computing device is included in, or is otherwise associated with, the database, or dictionary, for all the resource entries for an application 534.

If at decision block 532 it is determined that it is not the first time for the current application execution session that the resource has been accessed by the user, in an embodiment a count is updated to indicate the current resource access 536. In an aspect of this embodiment a new entry is generated in the database, or file, for the currently accessed resource 536. In an alternative aspect of this embodiment a counter associated with the entry for the currently accessed resource in the database, or file, is incremented 536.

In an alternative embodiment, if at decision block 532 it is determined that it is not the first time in the current application execution session that the resource has been accessed by the user the current resource usage is ignored.

In an embodiment information gathered on loaded resources of the application is uploaded to, or otherwise made accessible to, a computing device system for parsing and analysis 538. In an embodiment information gathered on the resources of the application that are used, or otherwise displayed, to a user is uploaded to, or otherwise made accessible to, a computing device system for parsing and analysis 538.

### Computing Device System Configuration

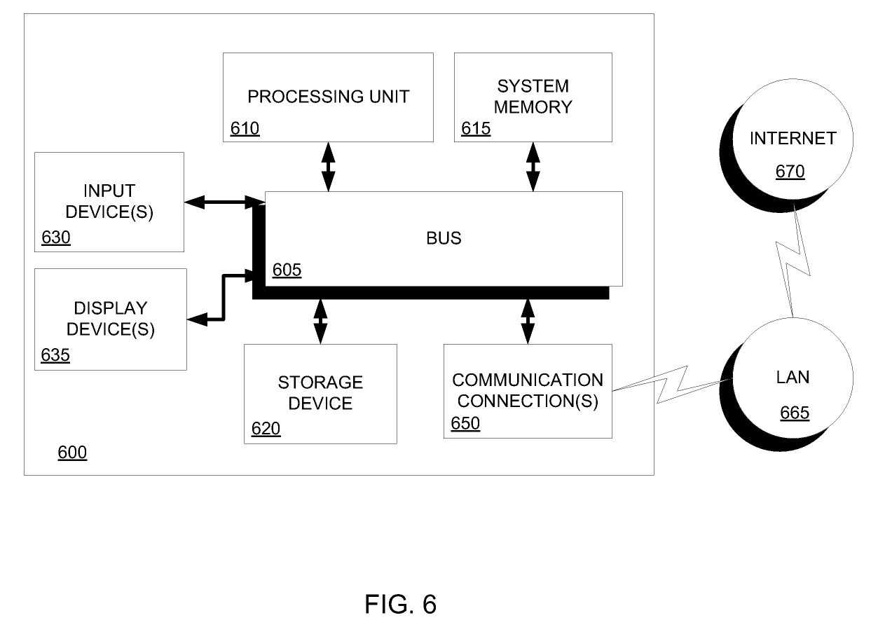

FIG. 6 is a block diagram that illustrates an exemplary computing device system 600 upon which an embodiment can be implemented. The computing device system 600 includes a bus 605 or other mechanism for communicating information, and a processing unit 610 coupled with the bus 605 for processing information. The computing device system 600 also includes system memory 615, which may be volatile or dynamic, such as random access memory (RAM), non-volatile or static, such as read-only memory (ROM) or flash memory, or some combination of the two. The system memory 615 is coupled to the bus 605 for storing information and instructions to be executed by the processing unit 610, and may also be used for storing temporary variables or other intermediate information during the execution of instructions by the processing unit 610. The system memory 615 often contains an operating system and one or more programs, and may also include program data.

In an embodiment, a storage device 620, such as a magnetic or optical disk, is also coupled to the bus 605 for storing information, including program code comprising instructions and/or data.

The computing device system 600 generally includes one or more display devices 635, such as, but not limited to, a display screen, e.g., a cathode ray tube (CRT) or liquid crystal display (LCD), a printer, and one or more speakers, for providing information to a computing device user. The computing device system 600 also generally includes one or more input devices 630, such as, but not limited to, a keyboard, mouse, trackball, pen, voice input device(s), and touch input devices, which a computing device user can use to communicate information and command selections to the processing unit 610. All of these devices are known in the art and need not be discussed at length here.

The processing unit 610 executes one or more sequences of one or more program instructions contained in the system memory 615. These instructions may be read into the system memory 615 from another computing device-readable medium, including, but not limited to, the storage device 620. In alternative embodiments, hard-wired circuitry may be used in place of or in combination with software program instructions. The computing device system environment is not limited to any specific combination of hardware circuitry and/or software.

The term “computing device-readable medium” as used herein refers to any medium that can participate in providing program instructions to the processing unit 610 for execution. Such a medium may take many forms, including but not limited to, storage media and transmission media. Examples of storage media include, but are not limited to, RAM, ROM, EEPROM, flash memory, CD-ROM, digital versatile disks (DVD), magnetic cassettes, magnetic tape, magnetic disk storage, or any other magnetic medium, floppy disks, flexible disks, punch cards, paper tape, or any other physical medium with patterns of holes, memory chip, or cartridge. The system memory 615 and storage device 620 of the computing device system 600 are further examples of storage media. Examples of transmission media include, but are not limited to, wired media such as coaxial cable(s), copper wire and optical fiber, and wireless media such as optic signals, acoustic signals, RF signals and infrared signals.

The computing device system 600 also includes one or more communication connections 650 coupled to the bus 605. The communication connection(s) 650 provide a two-way data communication coupling from the computing device system 600 to other computing devices on a local area network (LAN) 665 and/or wide area network (WAN), including the World Wide Web, or Internet 670. Examples of the communication connection(s) 650 include, but are not limited to, an integrated services digital network (ISDN) card, modem, LAN card, and any device capable of sending and receiving electrical, electromagnetic, optical, acoustic, RF or infrared signals.

Communications received by the computing device system 600 can include program instructions and program data. The program instructions received by the computing device system 600 may be executed by the processing unit 610 as they are received, and/or stored in the storage device 620 or other non-volatile storage for later execution.

### Conclusion

While various embodiments are described herein, these embodiments have been presented by way of example only and are not intended to limit the scope of the claimed subject matter. Many variations are possible which remain within the scope of the following claims. Such variations are clear after inspection of the specification, drawings and claims herein. Accordingly, the breadth and scope of the claimed subject matter is not to be restricted except as defined with the following claims and their equivalents.

What is claimed is:

1. A method for tracking resource usage for an application, the method comprising:
identifying a first resource of the application that is loaded by the application while the application is executing on a user's computing device;
storing a designation of the first resource of the application;
identifying a second resource of the application that is loaded by the application while the application is executing on the user's computing device;
storing a designation of the second resource of the application;
detecting that the first resource of the application is loaded with the second resource of the application to form a third resource;
storing a designation of the third resource of the application;
detecting that the third resource is a covered resource when the third resource is displayed to a user;
storing an identification of the third resource as a covered resource; and
providing access to the identification of the third resource as a covered resource to a computing device system.

2. The method for tracking resource usage for an application of claim 1, further comprising:
identifying a fourth resource of the application wherein the fourth resource is input by a user during execution of the application;
detecting that the fourth resource is loaded with the first resource of the application and the second resource of the application to form the third resource of the application; and
ignoring the fourth resource during the storing of the designation of the third resource of the application.

3. The method for tracking resource usage for an application of claim 1 wherein storing a designation of the first resource of the application comprises storing a first hash key for the first resource, storing an indication of the source file for the first resource and storing an indication of the resource location in the source file for the first resource; and wherein storing a designation of the second resource of the application comprises storing a second hash key for the second resource, storing an indication of the source file for the second resource and storing an indication of the resource location in the source file for the second resource.

4. The method for tracking resource usage for an application of claim 3 wherein storing a designation of the third resource comprising storing a third hash key for the third resource, storing an indication of the source file for the first resource, storing an indication of the resource location in the source file for the first resource, storing an indication of the source file for the second resource, and storing an indication of the resource location in the source file for the second resource.

5. The method for tracking resource usage for an application of claim 1 wherein storing a designation of the first resource of the application comprises generating an entry in a dictionary for the first resource wherein the entry for the first resource comprises a first hash key; wherein storing a designation of the second resource of the application comprises generating an entry in the dictionary for the second resource wherein the entry for the second resource comprises a second hash key; and wherein storing a designation of the third resource comprises generating an entry in the dictionary for the third resource wherein the entry for the third resource comprises a third hash key.

6. The method for tracking resource usage for an application of claim 1 wherein the third resource is a combination resource and wherein detecting that the first resource of the application is loaded with the second resource of the application to form the third resource comprises employing a shim to monitor functions that generate and load combination resources.

7. The method for tracking resource usage for an application of claim 1, further comprising:
using a hash key for the third resource of the application to search for the stored designation of the third resource of the application when the third resource of the application is displayed to a user; and
indicating that the third resource of the application is a covered resource in a resource usage file when the third resource of the application is displayed to the user and the stored designation of the third resource of the application is found using the hash key for the third resource of the application.

8. The method for tracking resource usage for an application of claim 1, further comprising:
identifying each resource of the application that is loaded by the application while the application is executing on a user's computing device and that has a source file location and a resource location in the source file;
storing a designation of each resource of the application that has a source file location, a resource location and that is loaded by the application while the application is executing on the user's computing device;
detecting each combination resource generated and loaded by the application while the application is executing on the user's computing device;
storing a designation of each combination resource that is generated and loaded by the application while the application is executing on the user's computing device and that is comprised of at least one resource of the application that has a source file location and a resource location in the source file;
detecting at least one resource of the application that is displayed to a user;
storing an identification of the at least one detected resource that comprises a designation that the at least one detected resource is a covered resource wherein the at least one detected resource is designated a covered resource; and
providing access to the identification of all the resources designated covered resources to a computing device system.

9. The method for tracking resource usage for an application of claim 8, further comprising employing a detour when the application loads a resource wherein the detour temporarily detours the application from execution while the loaded resource is identified and a designation of the loaded resource is stored.

10. The method for tracking resource usage for an application of claim 8 wherein each designation of each resource of the application that has a source file location, a resource location and that is loaded by the application while the application is executing on the user's computing device is stored in a dictionary; wherein each designation of each combination resource that is generated and loaded by the application while the application is executing on the user's computing device and that is comprised of at least one resource of the application that has a source file location and a resource location in the source file is stored in the dictionary; wherein the identification of each resource designated a covered resource is stored in a resource usage file; and wherein the resource usage file is uploaded to the computing device system.

11. A method for canvassing resource usage for an application, the method comprising:
identifying one or more resources of the application that are loaded by the application while the application is executing on a user's computing device;
storing a designation of each of the one or more identified resources of the application that are loaded by the application while the application is executing on the user's computing device;
identifying one or more resources of the application that are displayed to a user while the application is executing on a user's computing device;
indicating that a resource of the application that is displayed to a user and is identified as a resource of the application that is loaded by the application while the application is executing on a user's computing device is a covered resource of the application;
storing an identification of the covered resource; and
providing access to the identification of the covered resource to a computing device system.

12. The method for canvassing resource usage for an application of claim 11, further comprising:
indicating that all resources of the application that are displayed to a user and are identified as resources of the application that are loaded by the application while the application is executing on a user's computing device are covered resources of the application;
storing an identification of each covered resource; and
providing access to the identification of each covered resource to a computing device system.

13. The method for canvassing resource usage for an application of claim 11 wherein indicating that a resource of the application is a covered resource of the application comprises incrementing a counter in an entry of a resource usage file for the resource each time the resource of the application is displayed to the user during a session execution of the application and a stored designation of the resource is located.

14. The method for canvassing resource usage for an application of claim 11, further comprising employing a detour when the application loads a resource wherein the detour temporarily detours the application from execution while a designation of the loaded resource is stored.

15. The method for canvassing resource usage for an application of claim 11, further comprising:
storing user provided information when the application executes on a user's computing device; and
providing access to the user provided information to the computing device system.

16. A method for application resource coverage analysis, the method comprising:
identifying one or more resources of an application;
storing a designation of each identified resource of the application;
downloading local resource coverage analysis software to a user's computing device;
accessing information generated on a user's computing device by the local resource coverage analysis software while the application executed on the user's computing device wherein the information generated comprises an indication of one or more covered resources of the application and wherein a covered resource of the application is a resource of the application that was loaded by the application during an execution session of the application and that was displayed to a user during the execution session of the application; and
generating a resource coverage report on the application that comprises an identification of at least one covered resource of the application.

17. The method for application resource coverage analysis of claim 16, further comprising:
storing on a computing device system information generated by the local resource coverage analysis software while the application was executing on a user's computing device; and
generating a resource coverage report on the application that comprises an identification of at least one covered resource of an application for two or more application execution sessions.

18. The method for application resource coverage analysis of claim 16, further comprising generating a resource coverage report on the application that comprises an identification of the resources of the application that were not identified as a covered resource of the application during at least one execution session of the application.

19. The method for application resource coverage analysis of claim 16 wherein accessing information generated on a user's computing device by the local resource coverage analysis software while the application executed on the user's computing device comprises uploading a resource usage file generated by the local resource coverage analysis software from the user's computing device and wherein the resource usage file comprises an indication of each covered resource of the application identified during an execution session of the application on the user's computing device.

20. The method for application resource coverage analysis of claim 16, further comprising generating a resource coverage report on the application that comprises information requested by an analyst.
